(19) United States
(12) Patent Application Publication
(10) Pub. No.: US 2011/0050835 A1
(43) Pub. Date: Mar. 3, 2011

(54) EXPOSURE HEAD AND IMAGE FORMING APPARATUS

(75) Inventors: Takeshi SOWA, Matsumoto (JP); Ken IKUMA, Suwa (JP)

(73) Assignee: SEIKO EPSON CORPORATION, Tokyo (JP)

(21) Appl. No.: 12/843,584

(22) Filed: Jul. 26, 2010

(30) Foreign Application Priority Data
Sep. 2, 2009 (JP) 2009-202447

(51) Int. Cl. B41J 2/435

(52) U.S. Cl. 347/224

(57) ABSTRACT

An exposure head includes: a light emitting element substrate in which light emitting elements are arranged in a first direction; first lens arrays with first lenses, to which the light from the light emitting elements is incident, arranged thereon; second lens arrays with second lenses, to which the light emitting from the first lenses is incident, and each of which constitutes with each of the first lenses an optical system whose absolute value of a lateral magnification is less than one, arranged thereon; first spacers which are arranged on the light emitting element substrate and support the first lens arrays; and second spacers which are arranged on the first lens arrays so as to be in different positions from those of the first spacers when seen from an optical axis direction of the optical system and support the second lens arrays.

### BACKGROUND

1. Technical Field

The present invention relates to an exposure head, which uses a plurality of lens arrays, and an image forming apparatus.

2. Related Art

An exposure head using lens arrays in which lenses are aligned in arrays has been known in the related art. An exposure head using two lens arrays has been proposed in JP-A-2009-098613. In this exposure head, the two lens arrays are supported so as to oppose each other, and a plurality of lenses aligned in one lens array faces a plurality of lenses aligned in the other lens array so as to make a one-to-one corresponding relationship. In addition, two lenses facing each other in this manner cooperate and thus function as one optical system. Moreover, in the exposure head, a light emitting element is provided so as to oppose the respective optical system, and the respective optical system forms an image of light from the opposing light emitting element, thereby forming a spot on an exposure target surface such as a surface of an image carrier or the like.

When it is attempted to allow an absolute value of a magnification of the optical system to be less than one (that is, when it is attempted to set the magnification of the optical system so as to form an reduction image) in the configuration in which two lenses cooperate and thus function as one optical system, there may occur the following problems. That is, when the absolute value of the magnification of the optical system is set to be less than one, the position and the surface precision of the lens, which is placed closer to the exposure target surface, from among the two lenses constituting the optical system tend to affect more greatly the optical performance of the optical system. Meanwhile, the light emitting element generates heat when emitting light. Therefore, if the heat from the light emitting element is transmitted to the lens array in which the lens closer to the exposure target surface is arranged, a thermal deformation occurs in the lens array. Therefore, the position of the lens arranged in that lens array (that is, the lens closer to the exposure target surface) is varied, and the surface precision of the lens is deteriorated in some cases. As a result, there is a concern that the optical system cannot appropriately exhibit its optical performance.

### SUMMARY

An advantage of some aspects of the invention is to provide a technique for suppressing a thermal deformation of the lens array, in which lenses affecting more greatly the optical performance of the optical system are arranged, from among the lenses constituting the optical systems whose magnifications are less than one, and allowing the optical systems to appropriately exhibit their optical performances.

According to an aspect of the invention, there is provided an exposure head including: a light emitting element substrate in which light emitting elements are arranged in a first direction; first lens arrays with first lenses, to which the light from the light emitting elements is incident, arranged thereon; second lens arrays with second lenses, to which the light emitting from the first lenses is incident, and each of which constitutes with each of the first lenses an optical system whose absolute value of a lateral magnification is less than one, arranged thereon; first spacers which are arranged on the light emitting element substrate and support the first lens arrays; and second spacers which are arranged on the first lens arrays so as to be in different positions from those of the first spacers when seen from an optical axis direction of the optical system and support the second lens arrays.

The exposure head configured as described above is provided with the light emitting element substrate in which light emitting elements are arranged, the first lens arrays with first lenses, to which the light from the light emitting elements is incident, arranged thereon, and the second lens arrays with second lenses, to which the light emitting from the first lenses is incident, arranged thereon. The first lens arrays are supported by the first spacers, each of which is arranged between the first lens array and the light emitting element substrate. The second lens arrays are supported by the second spacers, each of which is arranged between the second lens array and the first lens array. Accordingly, when the light emitting elements in the light emitting element substrate generate heat along with the light emission, the heat is conducted to the first lens arrays via the first spacers in some cases. In such a case, if the heat is further conducted from the first lens arrays to the second lens arrays via the second spacers, there is a concern that the following problem may occur.

That is, in this exposure head, the light from the light emitting element is emitted from the first lens, then incident to the second lens, and subjected to the optical action by the optical system constituted by the first and second lenses. In addition, the absolute value of the lateral magnification of this optical system is less than one. In such a configuration, the position and the surface precision of the second lens greatly affect the optical performances of the optical system as in the same manner as described above. Accordingly, if the heat is conducted from the light emitting element substrate to the first lens array via the first spacer and then further conducted to the second lens array via the second spacer, and the thermal deformation occurs in the second lens array, the position of the second lens may be deviated, and the surface precision of the second lens may be deteriorated. As a result, there is a concern that the optical performances of the optical system may be degraded.

In order to solve this problem, according to this exposure head, the first spacers are arranged in the different positions from those of the second spacers when seen from the optical axis direction of the optical system. When the first and second spacers are arranged in different positions in this manner, it is possible to suppress the thermal conduction directing from the first spacers to the second spacers via the first lens arrays. Accordingly, it is possible to suppress the thermal conduction to the second lens arrays via the second spacers, and to thereby suppress the positional deviation of the second lenses along with the thermal deformations of the second lens arrays and the deterioration in the surface precision of the second lenses. As a result, it is possible to allow the optical systems constituted by the first and second lenses to exhibit their appropriate optical performances.

At this time, it is also applicable that first spacers and the second spacers are arranged in different positions in a second direction which is perpendicular to the first direction.

In addition, it is also applicable that the first spacers are arranged so as to be more distant from the optical axes of the optical systems in the second direction than the second spacers. The configuration in which the first spacers are further spaced from the optical axes of the second lenses than the second spacers in this manner is advantageous in suppressing the influence of the heat conducted to the first spacer on the optical performances of the optical systems (first and second lenses).

Moreover, it is also applicable that the width of the second spacer in the second direction is narrower than the width of the first spacer in the second direction. With this configuration, it is possible to further suppress the thermal conduction from the first spacers to the second lens arrays via the first lens arrays and the second spacers. As a result, it is possible to further suppress the positional deviation of the second lenses arranged in the second lens arrays, and to thereby allow the optical performances of the optical systems constituted by the first and second lenses to be more appropriate.

In addition, it is particularly preferable to apply the invention to the exposure head whose first spacers are made of a metal. That is, the first spacers made of a metal have a high thermal conductivity, thus the thermal conduction to the second lens array via the above-mentioned conduction path may easily occur. Accordingly, it is preferable to apply the invention to the exposure head configured as described above in order to suppress the thermal conduction to the second lens arrays, and thereby to secure the appropriate optical performances of the optical systems constituted by the first and second lenses.

In addition, it is particularly preferable to apply the invention to the exposure head provided with a driving element for driving the light emitting elements on the light emitting element substrate. That is, since the driving element generates heat along with the driving of the light emitting element, there is a concern that the heat from this driving element may be conducted to the second lens arrays via the above-mentioned conduction path. Accordingly, it is preferable to apply the invention to the exposure head with a driving element arranged on the light emitting element substrate in order to suppress the thermal conduction to the second lens array, and thereby to secure the appropriate optical performances of the optical systems constituted by the first and second lenses.

According to the invention, there is provided an image forming apparatus including: exposure heads, each of which includes a light emitting element substrate in which light emitting elements are arranged in a first direction, first lens arrays with first lenses, to which the light from the light emitting elements is incident, arranged thereon, second lens arrays with second lenses, to which the light emitted from the first lenses is incident, and each of which constitutes with each of the first lenses an optical system whose absolute value of a lateral magnification is less than one, arranged thereon, first spacers which are arranged on the light emitting element substrate and support the first lens arrays, and second spacers which are arranged on the first lens arrays so as to be in different positions from those of the first spacers when seen from an optical axis direction of the optical system and support the second lens arrays; and an image carrier which is irradiated with the light which is emitted from the light emitting elements and transmits through the optical systems constituted by the first lenses and the second lenses.

The image forming apparatus configured as described above is provided with the above-mentioned exposure head according to the invention. Therefore, there was a concern that above-mentioned problem due to the thermal deformations of the second lens arrays along with the heat generation of the light emitting elements occurred. Thus, in this image forming apparatus, the first spacers are arranged in different positions from those of the second spacers when seen from the optical axis direction of the optical system. When the first and second spacers are arranged in different positions in this manner, it is possible to suppress the thermal conduction directing from the first spacers to the second spacers via the first lens arrays. Accordingly, it is possible to suppress the thermal conduction to the second lens arrays via the second spacers, and to thereby suppress the positional deviation of the second lenses along with the thermal deformations of the second lens arrays and the deterioration in the surface precision of the second lenses. As a result, it is possible to allow the optical systems constituted by the first and second lenses to exhibit their appropriate optical performances.

According to the above-mentioned exposure head in the image forming apparatus, the first lens and the second lens constitutes one optical system, and the optical system emits light that became incident from the first lens to the second lens. An image carrier is irradiated with the light emitted from the second lens. In such a configuration, the second lens arrays with the second lenses arranged thereon are arranged so as to be close to the image carrier. The first spacers are arranged so as to be more distant from the optical axes of the optical systems in the second direction which is perpendicular to the first direction than the second spacers. The width of the second lens array in the second direction may be narrower than the width of the first lens array in the second direction. It is possible to enhance the degree of freedom in the layout of the exposure head with respect to the image carrier by setting the width of the second lens array, which is arranged in the vicinity of the image carrier, to be narrower.

### BRIEF DESCRIPTION OF THE DRAWINGS

The invention will be described with reference to the accompanying drawings, wherein like numbers reference like elements.

FIG. 1 is a diagram illustrating an example of an image forming apparatus to which the invention can be applied.

FIG. 2 is a block diagram illustrating an electronic configuration provided in the image forming apparatus shown in FIG. 1.

FIG. 3 is a partial perspective view illustrating a schematic configuration of a line head.

FIG. 4 is a partial plan view of a head substrate when seen from a thickness direction.

FIG. 5 is a partial sectional view of the line head taken along a line V-V.

FIG. 6 is a partial side view of the line head.

FIG. 7 is a detailed partial sectional view of the line head taken along the line VII-VII.

FIG. 8 is a diagram explaining a reason why a spacer SP1 and a spacer SP2 are arranged in different positions.

FIG. 9 is a diagram illustrating an arrangement relationship between the spacer SP1 and the spacer SP2.

### DESCRIPTION OF EXEMPLARY EMBODIMENTS

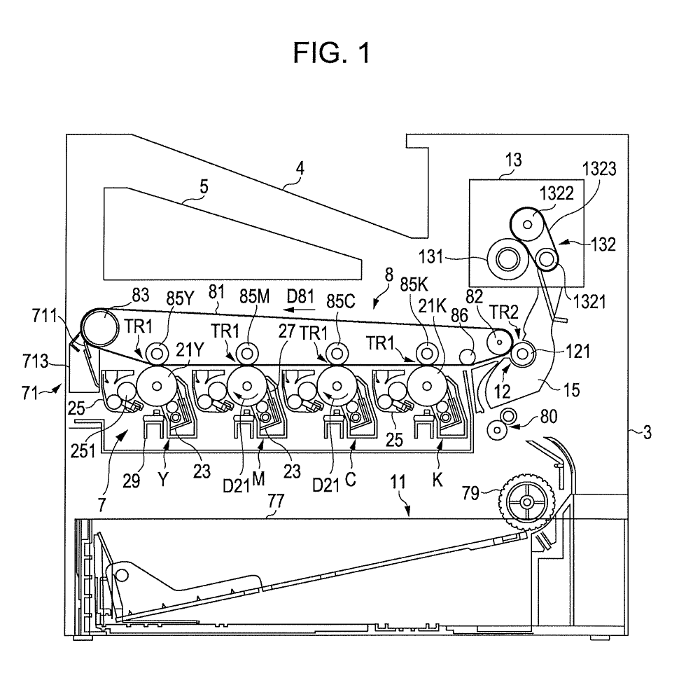

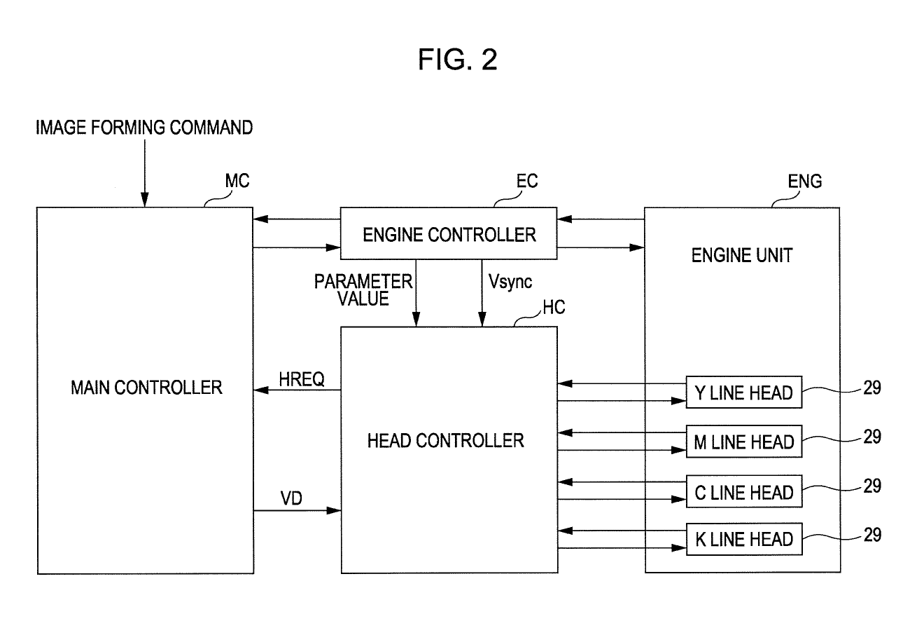

FIG. 1 is a diagram illustrating an example of an image forming apparatus to which the invention can be applied. FIG. 2 is a block diagram illustrating an electronic configuration provided in the image forming apparatus shown in FIG. 1. This apparatus is an image forming apparatus capable of selectively executing a color mode for forming a color image by superimposing toners of four colors including black (K), cyan (C), magenta (M), and yellow (Y) colors and a monochrome mode for forming a monochrome image by using only a toner of black (K) color. FIG. 1 is a drawing corresponding to the time when the color mode is executed. In this image forming apparatus, when an image forming command is supplied to a main controller MC provided with a CPU, a memory, and the like from an external apparatus such as a host computer, this main controller MC supplies a control signal or the like to an engine controller EC, and supplies video data VD corresponding to the image forming command to a head controller HC. At this time, the main controller MC supplies video data VD corresponding to one line in a main scanning direction MD to the head controller HC every time when receiving a horizontal request signal HREQ from the head controller HC. In addition, this head controller HC controls a line head 29 for each color based on the video data VD from the main controller MC and a parameter value and a vertical synchronization signal Vsync from the engine controller EC. With this configuration, an engine unit ENG executes a predetermined image forming operation, and forms an image corresponding to the image forming command on a sheet such as copy paper, transfer paper, paper, and transparent sheet for an OHP.

A housing main body 3 included in the image forming apparatus is provided therein with an electric component box 5 which embeds a power circuit substrate, the main controller MC, the engine controller EC, and the head controller HC. In addition, an image forming unit 7, a transfer belt unit 8, and a sheet feeding unit 11 are also arranged in the housing main body 3. In FIG. 1, a secondary transfer unit 12, a fixing unit 13, and a sheet guiding member 15 are arranged on the right side in the housing main body 3. The sheet feeding unit 11 is configured to be attachable and detachable with respect to an apparatus main body 1. The sheet feeding unit 11 and the transfer belt unit 8 are respectively configured such that they can be detached for repair and replacement.

The image forming unit 7 includes four image forming stations Y (for the yellow color), M (for the magenta color), C (for the cyan color), and K (for the black color) for forming an image with a plurality of different colors. Each of the image forming stations Y, M, C, and K is provided with a cylindrical photosensitive drum 21 having a surface with a predetermined length in the main scanning direction MD. Each of the image forming stations Y, M, C, and K forms a toner image of a corresponding color on a surface of the photosensitive drum 21. The photosensitive drum 21 is arranged such that the axial direction thereof is parallel or substantially parallel to the main scanning direction MD. In addition, each of the photosensitive drums 21 is respectively connected to a dedicated driving motor, and rotated and driven at a predetermined speed in a direction of an arrow D21 in the drawing. With this configuration, the surfaces of the photosensitive drums 21 are transported in a sub-scanning direction SD perpendicular or substantially perpendicular to the main scanning direction MD. A charging unit 23, a line head 29, a developing unit 25, and a photosensitive cleaner 27 are arranged along a rotation direction in the circumference of the photosensitive drum 21. These functional units execute a charging operation, a latent image forming operation, and a toner developing operation. Accordingly, a color image is formed by superimposing the toner images formed by all the image forming stations Y, M, C, and K onto a transfer belt 81 included in the transfer belt unit 8 at the time of executing the color mode, while the monochrome image is formed by using only the toner image formed by the image forming station K at the time of executing the monochrome mode. In FIG. 1, since each of the image forming stations in the image forming unit 7 has the same configuration, reference numerals are given only to a part of the image forming stations and omitted for the other image forming stations for the convenience of the illustration.

The charging unit 23 is provided with a charging roller with a surface constituted by a elastic rubber. This charging roller is configured to be driven and rotated while abutting on the surface of the photosensitive drum 21 at its charging position. The charging roller is driven and rotated at a rotation speed in a driven direction with respect to the photosensitive drum 21 along with the rotation operation of the photosensitive drum 21. In addition, this charging roller is connected to a charging bias generating unit (not shown), receives a charging bias supplied from the charging bias generating unit, and charges the surface of the photosensitive drum 21 at the charging position where the charging unit 23 abuts on the photosensitive drum 21.

The line head 29 is arranged so as to be spaced from the photosensitive drum 21. The longitudinal direction of the line head 29 is parallel or substantially parallel to the main scanning direction MD, and the width direction of the line head 29 is parallel or substantially parallel to the sub-scanning direction SD. This line head 29 is provided with a plurality of light emitting elements, and each of the light emitting elements emits light in accordance with the video data VD from the head controller HC. An electrostatic latent image is formed on the surface of the photosensitive drum 21 by irradiating the charged surface of the photosensitive drum 21 with the light from the light emitting elements.

The developing unit 25 includes a developing roller 251 which carries a toner on its surface. The charged toner is moved from the developing roller 251 to the photosensitive drum 21 at a developing position where the developing roller 251 abuts on the photosensitive drum 21, by a developing bias applied to the developing roller 251 from a developing bias generating unit (not shown) electrically connected to the developing roller 251, and the electrostatic latent image formed by the line head 29 is visualized.

The toner image visualized at the developing position in this manner is transported in the rotation direction D21 of the photosensitive drum 21, and then primarily transferred onto the transfer belt 81 at primary transfer positions TR1 at each of which the transfer belt 81 abuts on the respective photosensitive drums 21.

In this embodiment, a photosensitive cleaner 27 is provided on the downstream side of the primary transfer position TR1 in the rotation direction D21 of the photosensitive drum 21 and on the upstream side of the charging unit 23 so as to abut on the surface of the photosensitive drum 21. This photosensitive cleaner 27 abuts on the surface of the photosensitive drum and removes the toner remaining on the surface of the photosensitive drum 21 after the primary transfer.

The transfer belt unit 8 includes a driving roller 82, a driven roller 83 (blade opposing roller) arranged on the left side of the driving roller 82 in FIG. 1, and a transfer belt 81 which is stretched over these rollers and circularly driven in a direction of an arrow D81 in the drawing (transport direction). The transfer belt unit 8 is provided in the inner side of the transfer belt 81, and four primary transfer rollers 85Y, 85M, 85C, and 85K are respectively arranged so as to oppose the respective photosensitive drums 21 included in the respective image forming stations Y, M, C, and K at the time of mounting a photosensitive cartridge while making a one-to-one relationship. These primary transfer rollers 85 are electrically connected to primary transfer bias generating units (not shown), respectively. At the time of executing the color mode, all the primary transfer rollers 85Y, 85M, 85C, and 85K are positioned on the sides of the image forming stations Y, M, C, and K as shown in FIG. 1, the transfer belt 81 is pushed toward the photosensitive drums 21 included in the image forming stations Y, M, C, and K so as to abut on them, and primary transfer positions TR1 are formed between the respective photosensitive drums 21 and the transfer belt 81. A primary transfer bias is applied from the primary transfer bias generating unit to the primary transfer rollers 85 at an appropriate timing, and the toner image formed on the surface of the respective photosensitive drums 21 is transferred onto the surface of the transfer belt 81 at the corresponding primary transfer positions TR1 to thereby form a color image.

On the other hand, at the time of executing the monochrome mode, the primary color transfer rollers 85Y, 85M, and 85c are allowed to be spaced from the respectively opposing image forming stations Y, M, and C from among the four primary transfer rollers 85, and only the primary monochrome transfer roller 85K is allowed to abut on the image forming station K. Thus, only the monochrome image forming station K abuts on the transfer belt 81. As a result, the primary transfer position TR1 is formed only between the primary monochrome transfer roller 85K and the image forming station K. The primary transfer bias is applied from the primary transfer bias generating unit to the primary monochrome transfer roller 85K at an appropriate timing, and the toner image formed on the surface of the respective photosensitive drums 21 is transferred onto the surface of the transfer belt 81 at the primary transfer position TR1 to thereby form a monochrome image.

Moreover, the transfer belt unit 8 is provided with a downstream guide roller 86 arranged on the downstream side of the primary monochrome transfer roller 85K and the upstream side of the driving roller 82. This downstream guide roller 86 is configured to abut on the transfer belt 81 on an internal common tangent of the primary transfer roller 85K and the photosensitive drum 21 at the primary transfer position TR1 formed when the primary monochrome transfer roller 85K abuts on the photosensitive drum 21 of the image forming station K.

The driving roller 82 circularly drives the transfer belt 81 in the direction of the arrow D81 in the drawing, and also functions as a backup roller for a secondary transfer roller 121. A circumferential surface of the driving roller 82 is provided with a rubber layer formed thereon, which has a thickness of about 3 mm and a volume resistivity of not more than 1000 kΩ·cm and functions as a conduction path of the secondary transfer bias supplied from a secondary transfer bias generating unit (not shown) via the second transfer roller 121 by grounding it via a metal shaft. When the driving roller 82 is provided with a rubber layer which has a high frictional property and an impact absorbing property in the above manner, the impact generated when a sheet enters to the abutting portion (secondary transfer position TR2) between the driving roller 82 and the secondary transfer roller 121 is hardly transmitted to the transfer belt 81. Accordingly, it is possible to prevent the image quality from being deteriorated.

The sheet feeding unit 11 includes a sheet feeding section having a sheet feeding cassette 77 capable of holding sheets in a laminated manner and a pick-up roller 79 for feeding sheets one by one from the sheet feeding cassette 77. The sheet fed from the sheet feeding section by the pick-up roller 79 is fed to the secondary transfer position TR2 along the sheet guide member 15 after the adjustment of the sheet feeding timing by a resist roller pair 80.

The secondary transfer roller 121 is provided so as to be freely separated from and abutted on the transfer belt 81, and driven to be separated and abutted by a secondary transfer roller driving mechanism (not shown). The fixing unit 13 includes a freely rotatable heating roller 131 which installs a heat generating body such as a halogen heater or the like and a pressurizing section 132 for pressing and biasing this heating roller 131. The sheet with a surface on which an image was secondarily transferred is guided by the sheet guiding member 15 to a nip section formed by the heating roller 131 and a pressurizing belt 1323 of the pressurizing section 132, and the image is thermally fixed at a predetermined temperature at the nip section. The pressurizing section 132 includes two rollers 1321 and 1322 and a pressurizing belt 1323 stretched over these rollers. The nip portion formed by the heating roller 131 and the pressurizing belt 1323 is configured to be as large as possible by pressing the stretched belt surface, which is stretched by the two rollers 1321 and 1322 from among the surface of the pressurizing belt 1323, toward the circumferential surface of the heating roller 131. The sheet after this fixing process is transported to a paper discharge tray 4 provided on the upper surface portion of the housing main body 3.

In this apparatus, a cleaner unit 71 is arranged so as to oppose the blade opposing roller 83. The cleaner unit 71 includes a cleaner blade 711 and a waste toner box 713. The cleaner blade 711 removes foreign matters such as powder from the papers, toner remaining on the transfer belt after the secondary transfer, and the like by abutting its leading end portion on the blade opposing roller 83 via the transfer belt 81. The foreign matters removed in this manner are recovered in the waste toner box 713.

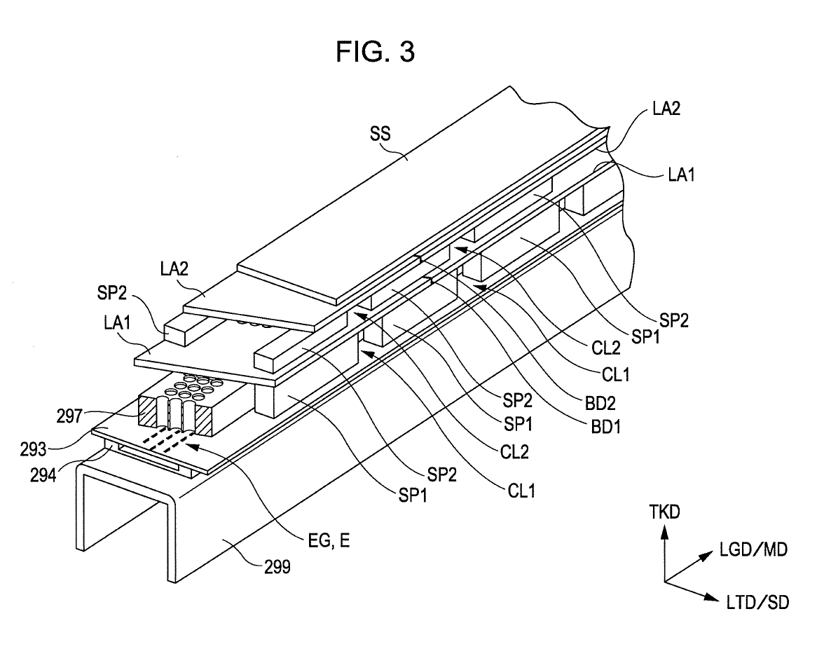

FIG. 3 is a partial perspective view illustrating the schematic configuration of the line head. FIG. 3 shows a section of an end portion of the line head 29 in the longitudinal direction LGD (lower left end portion in FIG. 3) for allowing the configuration of the line head 29 in the thickness direction TKD to be easily understood. Here, it is assumed that the thickness direction TKD is a direction perpendicular or substantially perpendicular to the longitudinal direction LGD and the width direction LTD, and a direction in which light emitting elements E, which will be described later, emit light (that is, a direction directing from the line head 29 toward the photosensitive drum 21). In the following description of the embodiment, the downstream side in the thickness direction TKD (upper side in FIG. 3) will be referred to as “one side (in the thickness direction TKD)”, and the upstream side in the thickness direction TKD (lower side in FIG. 3) will be referred to as “the other side (in the thickness direction TKD)”. In addition, the surface on one side of the substrate or a plate will be referred to as a front surface, and the surface on the other side of the substrate or the plate will be referred to as a rear surface.

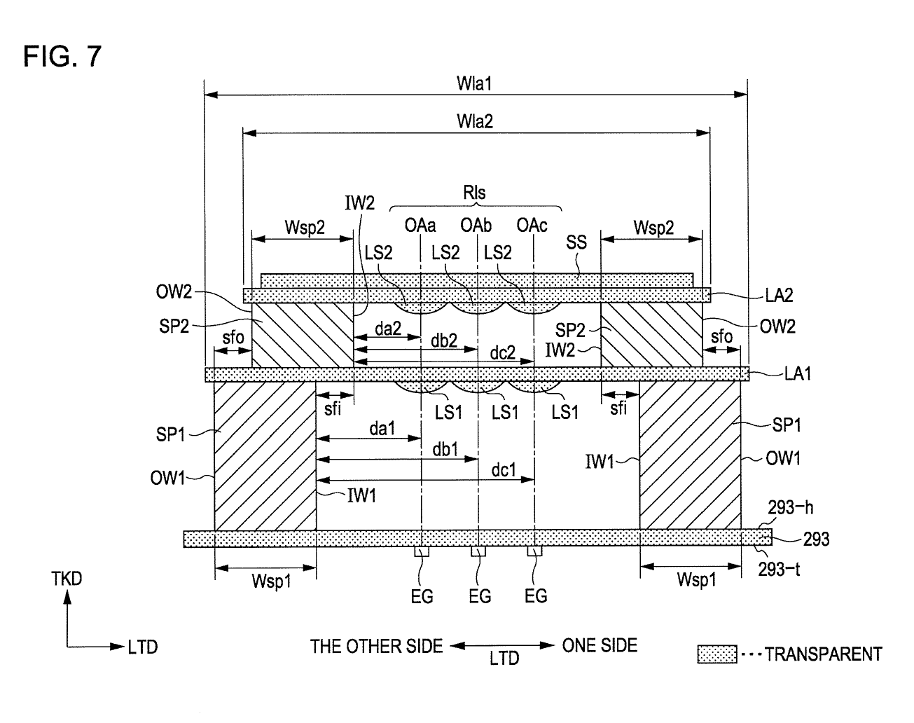

This thickness direction TKD is parallel with optical axes (optical axes OAa, OAb, and OAc in FIG. 7) of an image forming optical system constituted by a lens LS1 in a lens array LA1 and a lens LS2 in a lens array LA2. Here, the optical axis is defined as follows. In many cases, the image forming optical system is plane-symmetrical (reflective symmetry) with respect to a symmetry plane which is perpendicular to the main scanning direction MD, and also plane-symmetrical (reflective symmetry) with respect to a symmetry plane which is perpendicular to the sub-scanning direction SD. As described above, the image forming optical system includes a first symmetry plane which is perpendicular to the main scanning direction and a second symmetry plane which is perpendicular to the sub-scanning direction SD intersecting the main scanning direction MD at a right angle, and a line of intersection between the first symmetry plane and the second symmetry plane is defined. When the image forming optical system is rotationally symmetrical, the line of intersection between the first symmetry plane and the second symmetry plane coincides with the optical axis. When the image forming optical system is not rotationally symmetrical, the optical axis of the image forming optical system is not defined in some cases when strictly speaking. However, the aforementioned line of intersection may be regarded as the optical axis in such cases.

The line head 29 has a schematic configuration in which a head substrate 293, a light shielding member 297, a lens array LA1, and a lens array LA2 are arranged in this order in the thickness direction TKD. A predetermined plural number of light emitting elements E are made into a light emitting element group EG, and some light emitting element groups EG are two-dimensionally and discretely arranged on the rear surface of the head substrate 293. A sealing member 294 for sealing the plurality of light emitting elements E is attached to the rear surface of the head substrate 293. Moreover, a rigid member 299 for supporting the aforementioned respective members constituting the line head 29 is attached to the rear surface of this sealing member 294.

A spacer SP1 is provided between the head substrate 293 and the lens array LA1. This spacer SP1 defines the space between the head substrate 293 and the lens array LA1. In addition, the light shielding member 297 is arranged between the head substrate 293 and the lens array LA1, and the spacer SP1 supports the lens array LA1 with a small space between the lens array LA1 and the light shielding member 297 on one side in the thickness direction TKD. A spacer SP2 is provided between the lens array LA1 and the lens array LA2, and this spacer 2 supports the lens array LA2 while defining the space between the lens array LA1 and the lens array LA2.

In the line head 29, the head substrate 293, the light shielding member 297, and the lens arrays LA1 and LA2 are arranged in this order as described above. The light from the light emitting elements E on the head substrate 293 transmits through light guiding holes 2971 of the light shielding member 297, and an image is formed by the lenses LS1 and LS2 in the lens arrays LA1 and LA2. Next, detailed configuration of the respective members will be described with reference to FIGS. 3, 4, and 5.

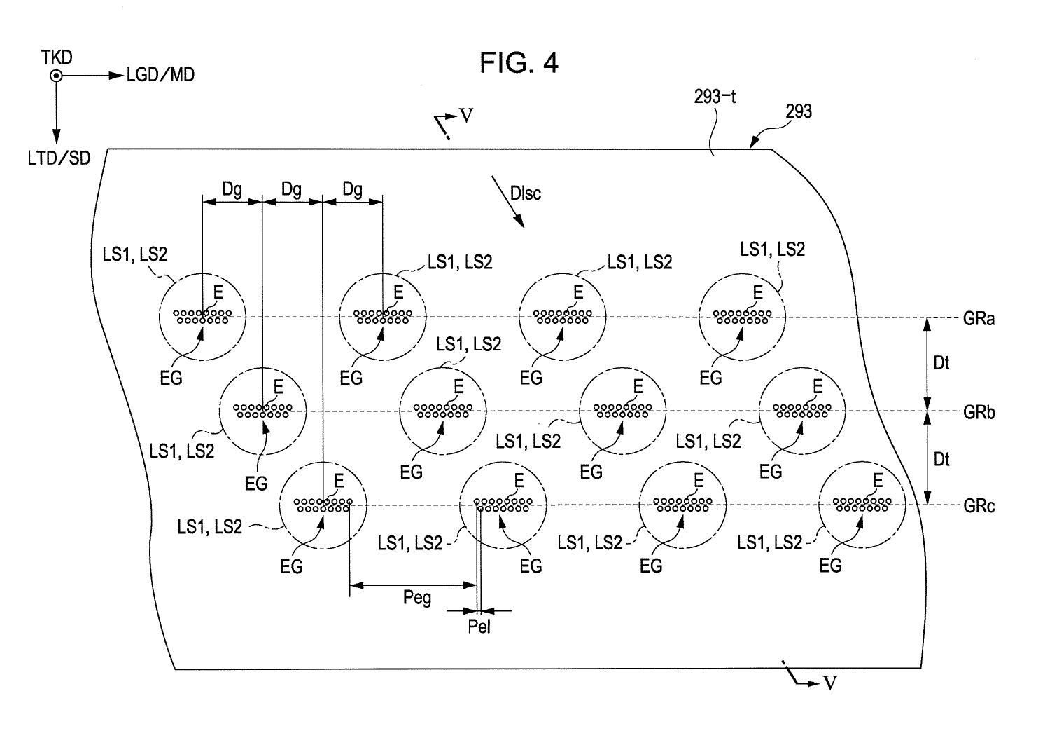

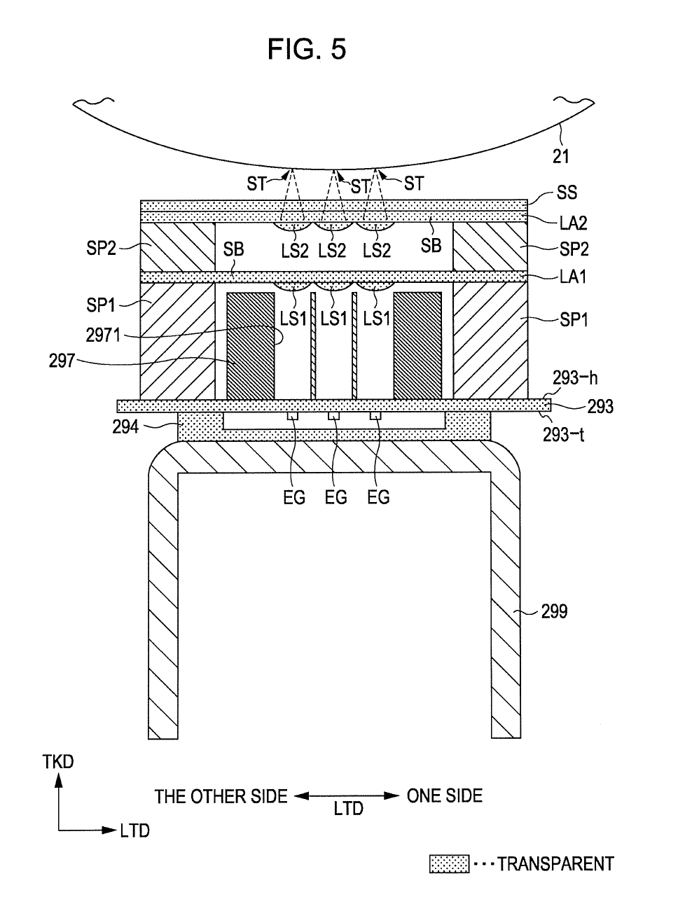

FIG. 4 is a partial plan view of the head substrate 293 when seen from the thickness direction TKD, and corresponds to the case of seeing the rear surface 293-t of the head substrate 293 through other components from one side (upper side in FIG. 3) in the thickness direction TKD. FIG. 5 is a partial sectional view of the line head taken along the line V-V, and corresponds to the case of seeing the section in the longitudinal direction LGD (main scanning direction MD). This sectional view taken along the line V-V passes through respective geometric gravity centers (or respective lens centers) of three light emitting element groups EG (or three lenses LS1, and the like) which are arranged in one column while being spaced with each other by a distance Dg in the longitudinal direction LGD and by a distance Dt in the width direction LTD. The direction Dlsc shown in FIGS. 4 and 5 is a direction parallel to the line V-V. Moreover, one-dotted dashed lines in FIG. 4 represent both the lenses LS1 and the lenses LS2 in order to show the positional relationship of the light emitting element groups EG formed on the head substrate 293, the lenses LS1 formed on the lens array LA1, and the lenses LS2 formed on the lens array LA2. In addition, the lenses LS1 and LS2 are shown in the same drawing in order to show the positional relationship therebetween, which does not mean that the lenses LS1 and LS2 are formed on the rear surface 293-t of the head substrate (FIG. 5). In FIG. 5, light permeable members (that is, transparent members) are shown by being hatched with plural dots.

The head substrate 293 is made of a glass substrate through which the light is permeable (light permeable substrate). A plurality of light emitting elements E, which are bottom emission type organic EL (Electro-Luminescence) elements, are formed on the rear surface 293-t of the head substrate, and sealed by the sealing member 294 (FIGS. 3 and 5). Each of the plurality of light emitting elements E has the same light emitting spectrum, and emits a light beam toward the surface of the photosensitive drum 21. As shown in FIG. 4, the plurality of the light emitting elements E formed on the rear surface 293-t of the head substrate is arranged so as to have a group structure. That is, fifteen light emitting elements E are arranged in a two-row zigzag manner in the longitudinal direction LGD to constitute one light emitting element group EG, and a plurality of light emitting element groups EG is discretely arranged in a three-row zigzag manner in the longitudinal direction LGD.

More specifically, this arrangement can be described as follows. That is, in the respective light emitting element groups EG, fifteen light emitting elements E are arranged in the positions which are different from each other in the longitudinal direction LGD, and the distance in the longitudinal direction LGD between two light emitting elements E and E, whose positions are adjacent to each other in the longitudinal direction LGD, corresponds to a distance between the elements Pel (in other words, fifteen light emitting elements E are arranged at the pitch Pel in the longitudinal direction LGD in the respective light emitting element groups EG). Moreover, a plurality of light emitting element group EG is discretely arranged along the longitudinal direction LGD while being spaced to each other by a distance between the groups Peg, which is longer than the distance between the elements Pel, to constitute one row of the light emitting element group GRa, or the like. Furthermore, three rows of light emitting element groups GRa, GRb, and GRc are discretely arranged in different positions in the width direction LTD while being spaced by a distance Dt, and mutually shifted by a distance Dg in the longitudinal direction LGD. As described above, three light emitting element groups EG are arranged in one column in the direction Dlsc while being spaced by the distance Dg in the longitudinal direction LGD and by the distance Dt in the width direction LTD.

Here, the distance between the elements Pel can be obtained as a distance between the geometric gravity centers of the two target light emitting elements E in the longitudinal direction LGD. In addition, the distance between the groups Peg can be obtained as a distance between the geometric gravity center of the light emitting element E, which is positioned in the end portion on the other side of the light emitting element group EG positioned on one side in the longitudinal direction LGD, and the geometric gravity center of the light emitting element E, which is positioned in the end portion on one side of the light emitting element group EG positioned on the other side in the longitudinal direction LGD, from among the two target light emitting element group EG. In addition, the distance Dg can be obtained as a distance in the longitudinal direction between the respective geometric gravity centers of the two light emitting element groups EG whose positions in the longitudinal direction LGD are adjacent to each other. The distance Dt can be obtained as a distance in the width direction LTD between the respective geometric gravity centers of the two light emitting element groups EG whose positions in the width direction LTD are adjacent to each other.

As described above, a plurality of light emitting element groups EG is two-dimensionally and discretely arranged on the rear surface 293-t of the head substrate 293. Meanwhile, a light shielding member 297 is arranged on the front surface 293-h of the head substrate 293. A plurality of light guiding holes 2971 is formed in the shielding member 297 so as to pass therethrough in the thickness direction TKD. The respective light guiding holes 2971 have a circular shape in a plan view from the thickness direction TKD, and a black coating was made on its inner wall. One light guiding hole 2971 is formed for each of the light emitting element groups EG. That is, one light guiding hole 2971 is opened for one light emitting element group EG. The light shielding member 297 is abutted on and fixed to the front surface 293-h of the head substrate in a state in which the light guiding holes 2971 are opened to the light emitting element groups EG.

Such a light shielding member 297 is provided in order to prevent so-called stray light from being incident to the lenses LS1 and LS2. That is, a dedicated image forming optical system constituted by a pair of the lens LS1 and the lens LS2 is provided for each of the light emitting element groups EG. In such a configuration, it is preferable that the light beam is incident only to the image forming optical system LS1, LS2 provided in the light emitting element group EG, which is the light emitting source of the light beam, to form an image. However, a part of the light beam does not direct to the image forming optical system LS1, LS2 provided in the light emitting element group EG, which is the light emitting source of the light beam, and becomes stray light. If the stray light is incident to the image forming optical system LS1, LS2 provided in the light emitting element group EG, which is not the light emitting source of the stray light, there is a fear that a so-called ghost may occur. In order to solve this problem, a light shielding member 297 is provided between the light emitting element group EG and the image forming optical system LS1, LS2 in this embodiment. Since this light shielding member 297 is provided with the light guiding holes 2971 with inner walls, for each of which a black coating was made, so as to open to the light emitting element groups EG, most of the stray light is absorbed by the inner walls of the light guiding holes 2971. As a result, it is possible to prevent the aforementioned ghost, and thereby to achieve a satisfactory exposure operation.

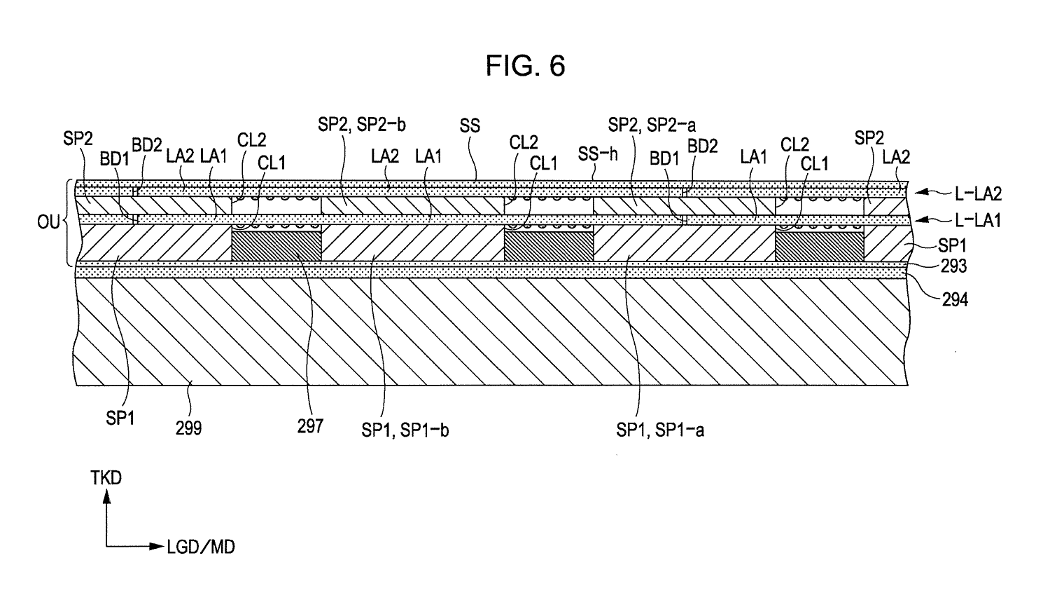

As described above, the lens arrays LA1 and LA2 are provided on one side in the thickness direction TKD of the head substrate 293 and the light shielding member 297, and supported by the spacers SP1 and SP2, respectively. Hereinafter, the detailed description will be made of the supporting structures for the lens arrays LA1 and LA2 with reference to FIG. 6 in addition to FIGS. 3 to 5.

FIG. 6 is a partial side view of the line head, and corresponds to the case of seeing the line head 29 in a plan view from the width direction LTD. A plurality of spacers SP1 with the same shape and size is arranged in a column while being spaced to each other at an interval CL1 in the longitudinal direction LGD on the front surface of the head substrate 293. This column of the spacers SP1 is provided on each side of the width direction LTD (FIGS. 3 and 5). As described above, two columns of the spacer SP1 are arranged so as to interpose in the width direction an area, in which the light emitting elements E are formed, on the rear surface 293-t of the head substrate when seen in a plan view from the thickness direction TKD (in other words, two columns are arranged so as to interpose the shielding member 297 in the width direction LTD). These spacers SP1 are fixed to the front surface 293-h of the head substrate 293 by an adhesive, or the like.

The lens array LA1 is bridged over the spacers SP1, which are arranged in two columns, in the width direction LTD in this manner. With this configuration, the lens array LA1 is positioned on one side in the thickness direction TKD of the head substrate 293. At this time, the lens array LA1 is arranged such that the area in the lens array LA1, in which the lenses LS1 are formed, is positioned between the two columns of the spacers SP1 arranged in the width direction LTD. This lens array LA1 includes a glass substrate SB with a parallelogram shape whose opposite ends in the longitudinal direction LGD were obliquely cut (so as to be parallel to the direction Dlsc). A plurality of lenses LS1 formed by photo-curable resin is arranged in arrays on the rear surface of this glass substrate SB. The plurality of lenses LS1 is arranged in a three-row zigzag manner so as to correspond to the arrangement of the opposing light emitting element groups EG (FIG. 4).

As shown in FIGS. 3 and 6, the plurality of lens arrays LA1 is arranged in the longitudinal direction LGD. That is, the spacers SP1 support the plurality of lens arrays LA1 arranged in the longitudinal direction LGD to constitute one lens array L-LA1 with a long length in this embodiment. In addition, a length of a spacer SP1 with a hexahedron shape is shorter than a length of an end side in the width direction LTD of the lens array LA1 in the longitudinal direction LGD, and one lens array LA1 is supported by a plurality of spacers SP1 arranged in the longitudinal direction LGD. Specifically, a center spacer SP1-b from among these spacers SP1 supports a substantially central portion of the lens array LA1 in the longitudinal direction LGD, and an end portion spacer SP1-a supports two lens arrays LA1 and LA1 which are adjacent to each other in the longitudinal direction LGD so as to cross over a gap BD1 between these two lens arrays LA1 and LA1. Moreover, the spacers SP1 and the lens arrays LA1 are fixed by an adhesive or the like.

A plurality of spacers SP2 with the same shape and size are arranged in a column while being spaced to each other by an interval CL2 in the longitudinal direction LGD, on one side surface of the lens array L-LA1 with a long length, which is configured as described above, in the thickness direction TKD. This column of the spacer SP2 is provided on each side of the width direction LTD (FIGS. 3 and 5). With this configuration, two columns of the spacers SP2 are arranged so as to interpose an area in the lens arrays LA1, in which the lenses LS1 are formed, in the width direction LTD when seen in a plan view from the thickness direction TKD. These spacers SP2 are fixed on the front surface of the glass substrates SB of the lens arrays LA1 by an adhesive or the like.

The lens array LA2 is bridged over the spacers SP2, which are arranged in two columns, in the width direction LTD in this manner. With this configuration, the lens array LA2 is positioned on one side in the thickness direction TKD of the lens array LA1. At this time, the lens array LA2 is arranged such that the area in the lens array LA2, in which the lenses LS2 are formed, is positioned between the two columns of the spacers SP2 arranged in the width direction LTD. This lens array LA2 includes a glass substrate SB with a parallelogram shape whose opposite ends in the longitudinal direction LGD were obliquely cut (so as to be parallel to the direction Dlsc). A plurality of lenses LS2 formed by photo-curable resin is arranged in arrays on the rear surface of this glass substrate SB. The plurality of lenses LS2 is arranged in a three-row zigzag manner so as to correspond to the arrangement of the opposing light emitting element groups EG (FIG. 4).

As shown in FIGS. 3 and 6, the plurality of lens arrays LA2 is arranged in the longitudinal direction LGD. That is, the spacers SP2 support the plurality of lens arrays LA2 arranged in the longitudinal direction LGD to constitute one lens array L-LA2 with a long length in this embodiment. In addition, a length of a spacer SP2 with a hexahedron shape is shorter than a length of an end side in the width direction LTD of the lens array LA2 in the longitudinal direction LGD, and one lens array LA2 is supported by a plurality of spacers SP2 arranged in the longitudinal direction LGD. Specifically, a center spacer SP2-b from among these spacers SP2 supports a substantially central portion of the lens array LA2 in the longitudinal direction LGD, and an end portion spacer SP2-a supports two lens arrays LA2 and LA2 which are adjacent to each other in the longitudinal direction LGD so as to cross over a gap BD2 between these two lens arrays LA2 and LA2. Moreover, the spacers SP2 and the lens arrays LA2 are fixed by an adhesive or the like.

As described above, the two lens arrays LA1 and LA2 are arranged so as to oppose each other in the thickness direction TKD. As a result, the plurality of lenses LS1 in the lens array LA1 and the plurality of lenses LS2 in the lens array LA2 are opposed to each other while making a one-to-one relationship, and the positions of the lens arrays LA1 and LA2 are adjusted such that the opposing lenses LS1 and LS2 are interposed with each other in a plan view from the thickness direction TKD.

In this embodiment, a supporting glass SS with a long length in the longitudinal direction LGD is also provided. Specifically, this supporting glass SS is formed so as to be longer than the length of the lens array LA2 in the longitudinal direction LGD, and has substantially the same length as that of the lens array L-LA2 with a long length. This supporting glass SS is attached to one side surface of the lens array L-LA2 with a long length, and supports the plurality of lens arrays LA2 from the opposite side of the spacers SP2. A surface SS-h (one side plane) of the supporting glass SS opposes the surface of the photosensitive drum 21 with a clearance.

In this embodiment, the lenses LS1 and LS2, which oppose each other in the thickness direction TKD, constitute one image forming optical system. This image forming optical system is for forming an inversed reduction image, and the lateral magnification is a negative value and has an absolute value of less than one. Accordingly, the light beams emitted from the light emitting elements E transmit through the lenses LS1 and LS2, are then emitted from the front surface SS-h of the supporting glass SS, and are irradiated onto the surface of the photosensitive drum 21 as spots ST (FIG. 5). As disclosed in FIG. 11 of JP-A-2008-036937, it is possible to form a line latent image extending in the main scanning direction MD by controlling the light emitting of the respective light emitting elements E in accordance with the movement of the surface of the photosensitive drum 21 in the sub-scanning direction SD.

FIG. 7 is a detailed partial sectional view of the line head taken along the line VII-VII, and corresponds to the case of seeing the sectional view from the longitudinal direction LGD (main scanning direction MD). FIG. 7 does not show the light shielding member 297. The detailed configuration of the line head 29 will be described with reference to the same drawing. As described above, two lens arrays LA1 and LA2 are arranged so as to oppose each other in the thickness direction TKD, and the lenses LS1 and LS2 are arranged in the respective lens arrays LA1 and LA2. The two lenses LS1 and LS2 opposing each other in the thickness direction TKD constitute one image forming optical system. In the same drawing, reference numerals OAa, OAb, and OAc are respectively given to the optical axes of the image forming optical systems in this order from the other side to one side of the width direction LTD, and a reference numeral Rls is given to a lens forming area in which the lenses LS1 and LS2 are formed in the plan view from the thickness direction TKD.

As shown in FIG. 7, the spacers SP1 are arranged on both sides of the lens forming area Rls in the width direction LTD on the front surface 293-h of the head substrate, and the lens array LA1 is bridged over these spacers SP1 and SP1. The spacers SP2 are arranged on both sides of the lens forming area Rls in the width direction LTD on the front surface of the lens array LA1, and the lens array LA2 is bridged over these spacers SP2 and SP2. The spacer SP1 has a hexahedron shape with a width Wsp1 in the width direction LTD, and is formed by a metal such as iron, or the like. The spacer SP2 has a hexahedron shape with a width Wsp2 in the width direction LTD, and is formed by a material with a thermal conductivity which is lower than that of the spacer SP1. In addition, the width Wsp1 of the spacer SP1 is equal to the width Wsp2 of the spacer SP2.

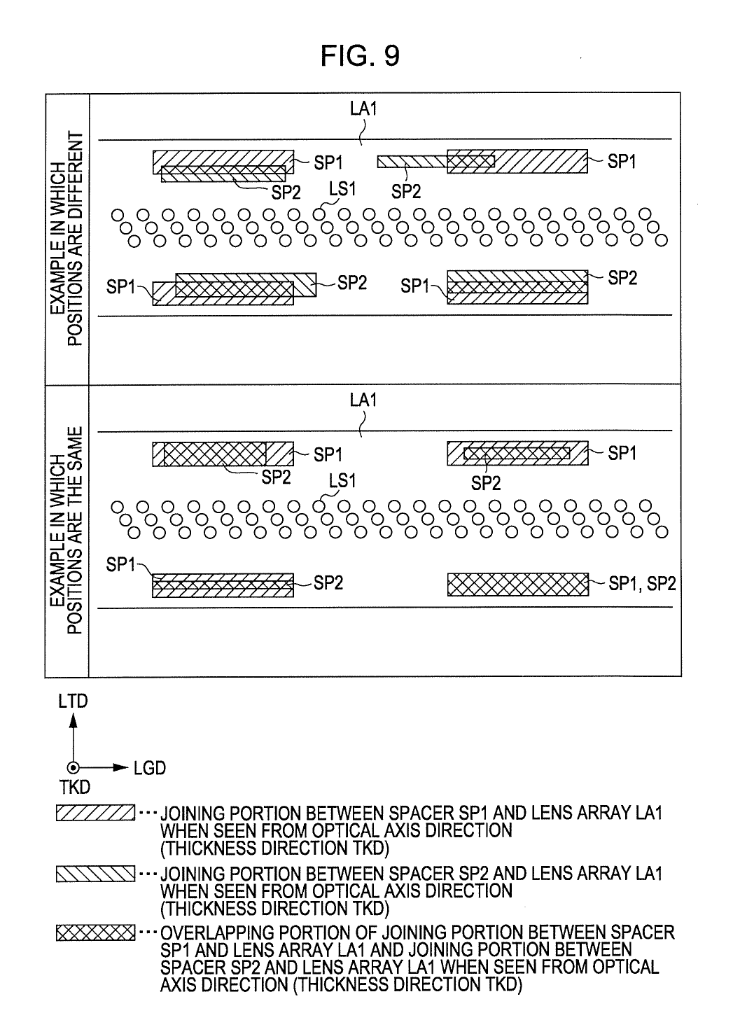

As described above, the spacers SP1 and SP2 are arranged so as to be laminated in the thickness direction TKD via the lens array LA1 in each of one side and the other side of the lens forming area Rls. The spacers SP1 and SP2, which are arranged so as to be laminated as described above, are shifted with each other in the width direction LTD, and arranged in the different positions when seen from the thickness direction TKD (optical axis direction). The expression that “the spacer SP1 is shifted with respect to the spacer SP2 toward one side (the other side) in the width direction LTD” used in this specification means the state in which in the width direction LTD, an inner wall IW1 of the spacer SP1 is shifted with respect to an inner wall IW2 of the spacer SP2 toward one side (the other side), and an outer wall OW1 of the spacer SP1 is also shifted with respect to an outer wall OW2 of the spacer SP2 toward one direction (the other side). Here, the inner walls IW1 and IW2 of the spacers SP1 and SP2 are the wall surfaces of the spacers SP1 and SP2 on the side of the lens forming area Rls, and the outer walls OW1 and OW2 of the spacers SP1 and SP2 are the wall surfaces of the spacers SP1 and SP2 on the other side of the lens forming area Rls. As will be described later with reference to FIG. 9, the expression that “the spacers SP1 and SP2 are arranged in the different positions when seen from the thickness direction TKD (optical axis direction)” means the case in which there is at least a part where the spacers SP1 and SP2 are not overlapped with each other when seen through other components in a plan view from the thickness direction TKD (optical axis direction). On the other hand, the expression that “the spacers SP1 and SP2 are arranged in the same position when seen from the thickness direction TKD (optical axis direction)” means the case in which the entire part of the spacer SP2 is positioned completely within the spacer SP1 when seen through other components in a plan view from the thickness direction TKD (optical axis direction).

Hereinafter, the arrangement of the spacers SP1 and SP2 will be described while exemplifying the spacers SP1 and SP2 arranged on the other side in the width direction LTD as their representative. As shown in FIG. 7, the spacer SP1 is arranged so as to be shifted with respect to the spacer SP2 toward the other side in the width direction LTD. That is, the inner wall IW1 of the spacer SP1 is shifted with respect to the inner wall IW2 of the spacer SP2 toward the other side in the width direction LTD by a shift amount sfi, and the outer wall OW1 of the spacer SP1 is shifted with respect to the outer wall OW2 of the spacer SP2 toward the other side in the width direction LTD by a shift amount sfo. Since the width Wsp1 of the spacer SP1 is equal to the width Wsp2 of the spacer SP2, the shift amount sfi of the inner wall surface is equal to the shift amount sfo of the outer wall surface. As described above, the spacer SP1 is arranged so as to be shifted with respect to the spacer SP2 toward the outer side in the width direction LTD. As a result of this arrangement, the distances da1, db1, and dc1 between the spacer SP1 and the respective optical axes OAa, OAb, and OAc of the image forming optical systems are longer than the distance da2, db2, and dc2 between the spacer SP2 and the respective optical axes OAa, OAb, and OAc of the image forming optical systems (that is, da1>da2, db1>db2, dc1>dc2).

The spacers SP1 and SP2 on one side in the width direction LTD are also arranged in the same arrangement, and the spacers SP1 are also arranged on one side in the width direction LTD so as to be shifted with respect to the spacer SP2 toward the outer side in the width direction LTD. As a result, the interval between the spacers SP2 and SP2 arranged on the opposite sides in the width direction LTD is narrower than the interval between the spacers SP1 and SP1 arranged on the opposite sides in the width direction LTD. In this embodiment, the widths Wla1 and Wla2 of the lens arrays LA1 and LA2 in the width direction LTD are allowed to be changed in accordance with the difference in the intervals of the spacers SP1 and the spacers SP2, which support the lens arrays LA1 and LA2, respectively, and the width Wla2 of the lens array LA2 is set to be narrower than the width Wla1 of the lens array LA1 (width Wla2<width Wla1).

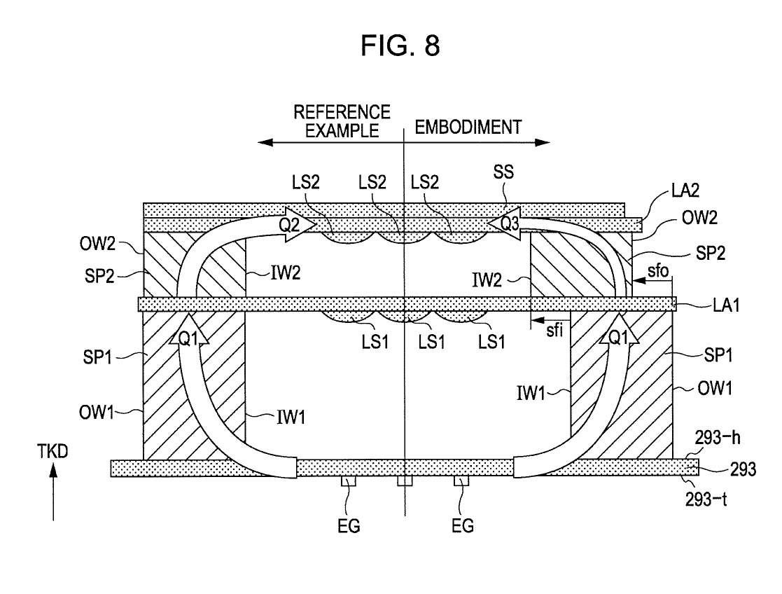

As described above, according to this embodiment, the spacer SP1 is arranged so as to be shifted with respect to the spacer SP2, and the spacers SP1 and SP2 are arranged in the different positions when seen from the thickness direction TKD (optical axis direction). Next, the description will be made of the reason why such arrangements are employed for the spacers SP1 and SP2 with reference to FIG. 8 in addition to FIG. 7. FIG. 8 is a diagram explaining a reason why the spacers SP1 and SP2 are arranged in different positions when seen from the thickness direction TKD (optical axis direction), and a reference example (the left half of the same drawing) is also shown in addition to the structure of this embodiment (the right half of the same drawing). The arrows with the reference numerals Q1 to Q3 in FIG. 8 show the heat conducted in the arrow directions, and the width of the respective arrows schematically represents the heat amount of the heat Q1 to Q3, respectively.

In the line head shown in FIGS. 7 and 8, when the light emitting elements E (light emitting element groups EG) formed on the head substrate 293 generate heat along with the emission of the light, the heat Q1 from the light emitting elements E (light emitting element groups EG) is conducted to the lens arrays LA1 via the spacers SP1 in some cases. In such cases, if the heat is further conducted from the lens arrays LA1 to the lens arrays LA2 via the spacers SP2, the following problem may occur.

That is, in this line head 29, the light from the light emitting element E is emitted from the lens LS1, then incident to the lens LS2, and thereby subjected to the optical action by the image forming optical system constituted by these lenses LS1 and LS2. Moreover, the absolute value of the lateral magnification of this image forming optical system is less than one. With such a configuration, the position and the surface precision of the lens LS2 (the lens on the side of the image surface from among the lenses constituting the image forming optical system) greatly affect the optical performances such as the image forming performance of the optical system, and the like. For this reason, if the heat is conducted from the head substrate 293 to the lens array LA1 via the spacer SP1, and further to the lens array LA2 via the spacer SP2, and the thermal deformation occurs in the lens array LA2, the position of the lens LS2 may be deviated, or the surface precision of the lens may be deteriorated. As a result, there is a fear that the optical performances of the image forming optical system may be degraded.

In order to solve this problem, the spacers SP1 and SP2 are arranged in the different positions when seen from the thickness direction TKD (optical axis direction) in this line head 29. When the spacers SP1 and SP2 are arranged in different positions in the thickness direction TKD (optical axis direction) in this manner, it is possible to suppress the thermal conduction directing from the spacer SP1 to the spacer SP2 via the lens array LA1. Accordingly, it is possible to suppress the thermal conduction to the lens array LA2 via the spacer SP2. The description will be made while comparing the reference example and the embodiment with reference to FIG. 8. As shown in FIG. 8, the heat amount of the heat Q2 conducted to the lens array LA2 is relatively large in the reference example in which the spacer SP1 is not shifted with respect to the spacer SP2. On the other hand, the heat amount of the heat Q3 conducted to the lens array LA2 is suppressed to be a relatively small amount in the embodiment in which the spacer SP1 is shifted with respect to the spacer SP2. Accordingly, it is possible to suppress the thermal deformation of the lens array LA2, and to thereby suppress the positional deviation of the lens LS2. As a result, it is possible to allow the image forming optical system constituted by the lenses LS1 and LS2 to exhibit its appropriate optical performances.

In this embodiment, the spacers SP1 are arranged in the positions more distant from (the axis of) the image forming optical system than the spacers SP2 in the width direction LTD. Such a configuration is advantageous in suppressing the influence of the heat conducted to the spacer SP1 on the optical performances of the image forming optical system.

It is preferable that the invention is applied to the line head 29 whose spacer SP1 is made of metal as in this embodiment. That is, since the spacer SP1 made of metal has a high thermal conductivity, the thermal conduction to the lens array 2 via the above-mentioned conduction path (the light emitting element E→the head substrate 293→the spacer SP1→the lens array LA1→the spacer SP2) easily occurs. Accordingly, it is preferable to secure the appropriate optical performances of the optical system constituted by the lenses LS1 and LS2 by applying the invention to such a line head 29 to suppress the thermal conduction to the lens array LA2.

In addition, the line head 29 is arranged so as to be close to the photosensitive drum 21 inside the image forming apparatus in order to irradiate the surface of the photosensitive drum 21 with the spots ST. Accordingly, the lens array LA2 is arranged in an opposing manner so as to be close to the photosensitive drum 21. In this embodiment, the width Wla2 of the lens array LA2 is narrower than the width Wla1 of the lens array LA1. With this configuration, it is possible to suppress the width of the lens array LA2, which opposes the photosensitive drum 21 so as to be close thereto, in the rotation direction of the photosensitive drum 21 (sub-scanning direction SD). Therefore it is possible to sufficiently secure the space for arranging other functional units (charging unit 23) and the like in the circumference of the line head 29, and to thereby enhance the degree of freedom in the layout of the line head 29 with respect to the photosensitive drum 21.

### Others

As described above, the line head 29 in the embodiment corresponds to the “exposure head” in the invention. The head substrate 293 corresponds to the “light emitting element substrate” in the invention, the lens array LA1 corresponds to the “first lens array” in the invention, the lens array LA2 corresponds to the “second lens array” in the invention, the lens LS1 corresponds to the “first lens” in the invention, the lens LS2 corresponds to the “second lens” in the invention, the spacer SP1 corresponds to the “first spacer” in the invention, the spacer SP2 corresponds to the “second spacer” in the invention, and the image forming optical system constituted by the lenses LS1 and LS2 corresponds to the “optical system” in the invention. In addition, the longitudinal direction LGD and the main scanning direction MD correspond to the “first direction” in the invention, and the width direction LTD and the sub-scanning direction SD correspond to the “second direction” in the invention.

The invention is not limited to the above embodiment, and various modification can be added to the above embodiment without departing from the gist. For example, although the width Wsp2 of the spacer SP2 is equal to the width Wsp1 of the spacer SP1 in the above embodiment, the relationship between the widths of the spacers SP1 and SP2 are not limited thereto. The width Wsp2 of the spacer SP2 may be narrower than the width Wsp1 of the spacer SP1. With such a configuration, it is possible to further suppress the thermal conduction from the spacer SP1 to the lens array LA2 via the lens array LA1 and the spacer SP2. As a result, it is possible to further suppress the positional deviation of the lens LS2 arranged in the lens array LA2, and to thereby allow the optical performances of the optical system constituted by the lenses LS1 and LS2 to be more appropriate.

In the above embodiment, the spacers SP1 and SP2 are arranged in different positions when seen from the thickness direction TKD (optical axis direction) by allowing the spacers SP1 and SP2 to be shifted with each other in the width direction LTD. However, various modifications can be made for the arrangement relationship between the spacers SP1 and SP2. In short, it is possible to achieve the above effect by arranging the spacers SP1 and SP2 in the different positions when seen from the thickness direction TKD (optical axis direction), that is, by arranging the spacers SP1 and SP2 in a manner which will be described below with reference to FIG. 9.

FIG. 9 is a diagram illustrating an arrangement relationship between the spacer SP1 and the spacer SP2 when seen through other components in a plan view from the thickness direction TKD (optical axis direction), and shows both the case (upper portion of the same drawing) in which the spacers SP1 and SP2 are arranged in the different positions when seen from the thickness direction TKD (optical axis direction) and the case (lower portion of the same drawing) in which the spacers SP1 and SP2 are arranged in the same position when seen from the thickness direction TKD (optical axis direction). FIG. 9 shows the joining portion between the spacer SP1 and the lens array LA1 as the representative of the spacer SP1, and shows the joining portion between the spacer SP2 and the lens array LA2 as the representative of the spacer SP2. In addition, the joining portion between the spacer SP1 and the lens array LA1 (first joining portion) is shown by being hatched with a plurality of diagonal lines from the upper right side to the lower left side, and the joining portion between the spacer SP2 and the lens array LA2 (second joining portion) is shown by being hatched with a plurality of diagonal lines from the upper left side to the lower right side. The overlapping portion between the first joining portion and the second joining portion (in other words, the overlapping portion between the spacers SP1 and SP2) is shown by being hatched with a plurality of diagonal lines intersecting with each other.

In any of the four examples showing the arrangement relationships in the upper portion of the same drawing, the spacers SP1 and SP2 are partially overlapped with each other while the other portions are not overlapped with each other, and are arranged in different positions when seen through other components in a plan view from the thickness direction TKD (optical axis direction). As a result, the area of the overlapping portion between the first joining portion and the second joining portion is smaller than the area of any one of the areas of the first joining portion and the second joining portion, which is smaller than the other. On the other hand, in any of the four examples showing the arrangement relationships in the lower portion of the same drawing, the entire part of the spacer SP2 is completely within the spacers SP1, and the spacers SP1 and SP2 are arranged in the same position when seen through other components in a plan view from the thickness direction TKD (optical axis direction). It is possible to achieve the above effects by arranging the spacers SP1 and SP2 in the different positions when seen from the thickness direction TKD (optical axis direction) as shown in the upper portion of the same drawing.

In addition, it is also applicable that a driving element such as a TFT (Thin Film Transistor) is provided on the rear surface 293-t of the head substrate 293 so as to cause the driving element to drive the light emitting element E. It is particularly preferable to apply the invention to such a configuration. That is, since the driving element generates heat along with the driving of the light emitting element, the heat from this driving element may be conducted to the lens array LA2 via the above-mentioned conduction path. Accordingly, it is preferable to apply the invention to the line head 29 with a driving element arranged on the head substrate 293 in order to suppress the thermal conduction to the lens array LA2, and thereby to secure the optical performances of the image forming optical system constituted by the lenses LS1 and LS2.

Although the above embodiment was described such that the supporting glass SS was provided, it is also applicable that the supporting glass SS is not provided.

In addition, various modifications can be made for the dimensional relationships of the respective members such as the lens array LA1, the lens array LA2, and the like, and the dimensional relationships other than the ones described above are also applicable.

Although the above embodiment was described such that the plurality of lens arrays LA1 had the same shape and size, various modifications can be made regarding this configuration. In addition, similar modifications can be made for the plurality of lens arrays LA2.

Although the above embodiment was described such that the plurality of spacers SP1 had the same shape and size, various modifications can be made regarding this configuration. In addition, similar modifications can be made for the plurality of spacers SP2.

Although the above embodiment was described such that the image forming optical system is for forming the inversed image, it is also applicable that the image forming optical system is for forming a normal image (that is, a non-inverted image).

Although the above embodiment was described such that the lenses LS1 are formed on the rear surface (the other side surface in the thickness direction TKD) of the lens array LA1, the position for forming the lenses LS1 is not limited thereto. The same is true for the lenses LS2 in the lens array LA2.

Although the above embodiment was described such that the lenses are arranged in a three-row zigzag manner in each of the lens arrays LA1 and LA2, the arrangement of the lenses is not limited thereto.

The lens arrays LA1 and LA2 in the above embodiment were described such that the lenses LS1 and LS2 made of resin are formed in the light permeable substrate SB made of glass. However, it is also applicable that each of the lens arrays LA1 and LA2 is integrally formed by one material.

Although the above embodiment was described such that the plurality of the light emitting element groups EG is arranged in a three-row zigzag manner, the arrangement of the plurality of light emitting element groups EG is not limited thereto.

The above embodiment was described such that the light emitting element group EG is constituted by fifteen light emitting elements E. However, the numbers of the light emitting elements E constituting the light emitting element group EG is not limited thereto.

Although the above embodiment was described such that the plurality of the light emitting elements E is arranged in a two-row zigzag manner in a light emitting element group EG, the arrangement of the plurality of light emitting elements E in the light emitting element group EG is not limited thereto.

The above embodiment was described such that the bottom emission type organic EL elements were used as the light emitting elements. However, the top emission type organic EL (Electro-Luminescence) elements may be used as the light emitting elements E. Alternatively, LEDs (Light Emitting Diodes) or the like other than the organic EL elements may be used as the light emitting elements E.

The entire disclosure of Japanese Patent Applications No. 2009-202447, filed on Sep. 2, 2009 is expressly incorporated by reference herein.

What is claimed is:

1. An exposure head comprising:
a light emitting element substrate in which light emitting elements are arranged in a first direction;
first lens arrays with first lenses, to which the light from the light emitting elements is incident, arranged thereon;
second lens arrays with second lenses, to which the light emitted from the first lenses is incident, and each of which constitutes with each of the first lenses an optical system whose absolute value of a lateral magnification is less than one, arranged thereon;
first spacers which are arranged on the light emitting element substrate and support the first lens arrays; and
second spacers which are arranged on the first lens arrays so as to be in different positions from those of the first spacers when seen from an optical axis direction of the optical system and support the second lens arrays.

2. The exposure head according to claim 1,
wherein the first spacers and the second spacers are arranged in different positions in a second direction which is perpendicular to the first direction.

3. The exposure head according to claim 2,
wherein the first spacers are arranged so as to be more distant from the optical axes of the optical systems in the second direction than the second spacers.

4. The exposure head according to claim 2,
wherein the width of the second spacer in the second direction is narrower than the width of the first spacer in the second direction.

5. The exposure head according to claim 2,
wherein the width of the second lens array in the second direction is narrower than the width of the first lens array in the second direction.

6. The exposure head according to claim 1,
wherein the first spacers are made of a metal.

7. The exposure head according to claim 1,
wherein the light emitting element substrate is provided with a driving element for driving the light emitting elements.

8. An image forming apparatus comprising:
exposure heads, each of which includes a light emitting element substrate in which light emitting elements are arranged in a first direction, first lens arrays with first lenses, to which the light from the light emitting elements is incident, arranged thereon, second lens arrays with second lenses, to which the light emitted from the first lenses is incident, and each of which constitutes with each of the first lenses an optical system whose absolute value of a lateral magnification is less than one, arranged thereon, first spacers which are arranged on the light emitting element substrate and support the first lens arrays, and second spacers which are arranged on the first lens arrays so as to be in different positions from those of the first spacers when seen from an optical axis direction of the optical system and support the second lens arrays; and
an image carrier which is irradiated with the light which is emitted from the light emitting elements and transmits through the optical systems constituted by the first lenses and the second lenses.

9. The image forming apparatus according to claim 8,
wherein the first spacers are arranged so as to be more distant from the optical axes of the optical systems in the second direction than the second spacers; and
wherein the width of the second lens array in a second direction which is perpendicular to the first direction is narrower than the width of the first lens array in the second direction.
